(19) United States
(12) Patent Application Publication
(10) Pub. No.: US 2026/0319297 A1
(43) Pub. Date: Oct. 15, 2026

(54) DISPLAY DEVICE

(71) Applicant: LG Display Co., Ltd., Seoul (KR)

(72) Inventors: Heon Soo HA, Gumi-si, Gyeongsangbuk-do (KR); Yun Ho CHO, Paju-si, Gyeonggi-do (KR)

(73) Assignee: LG Display Co., Ltd., Seoul (KR)

(21) Appl. No.: 19/484,317

(22) PCT Filed: Jan. 22, 2025
(86) PCT No.: PCT/KR2025/001203

§ 371 Date: Nov. 13, 2025

(30) Foreign Application Priority Data
Feb. 22, 2024 (KR) 10-2024-0025945

(51) Int. Cl. F21V 8/00

(52) U.S. Cl. CPC G02B 6/0038; G02B 6/0068

(57) ABSTRACT

According to an aspect of the present disclosure, a display device includes a first light source unit including a plurality of first light sources; a first light controller disposed on the first light source unit and includes a plurality of partitions overlapping at least a partial area of the active area; a second light source unit disposed on the first light controller and includes a plurality of second light sources; a light guide plate disposed to be parallel to the second light source unit and guides light provided from the second light source unit; a second light controller disposed on the light guide plate and includes a plurality of prism patterns overlapping at least a partial area of the active area; and a display panel disposed on the second light controller and displays an image using light provided from the first light source unit or the second light source unit.

### TECHNICAL FIELD

The present disclosure relates to a display device, and more particularly to a display device in which a viewing angle is controllable.

### BACKGROUND ART

As the technology in modern society develops, display devices are used in various ways to provide information to users. The display devices are included in not only electronic signs which simply transmit visual information in one direction, but also various electronic devices which require a higher level of technology to check user's input and provide information in response to the checked input.

For example, a display device is included in a vehicle to provide various information to a driver and a passenger of the vehicle. However, the display device for the vehicle needs to appropriately display contents without interrupting the operation of the vehicle. For example, the display device needs to limit the display of the contents which may reduce the concentration on the driving while the vehicle is in operation.

### DISCLOSURE

### Technical Problem

An object to be achieved by the present disclosure is to provide a display device which provides contents in a first area of an active area at a wide viewing angle and provides contents in a second area at a wide viewing angle or a narrow viewing angle, depending on a driving mode.

Another object to be achieved by the present disclosure is to provide a display device in which in a second mode in which contents are provided at a narrow viewing angle in a second area, an image displayed in the second area is not visible to a user who is located in the first area to effectively control the viewing angle in the second mode.

Objects of the present disclosure are not limited to the above-mentioned objects, and other objects, which are not mentioned above, can be clearly understood by those skilled in the art from the following descriptions.

### Technical Solution

According to an aspect of the present disclosure, a display device includes a first light source unit including a plurality of first light sources; a first light controller disposed on the first light source unit and includes a plurality of partitions overlapping at least a partial area of the active area; a second light source unit disposed on the first light controller and includes a plurality of second light sources; a light guide plate disposed to be parallel to the second light source unit and guides light provided from the second light source unit; a second light controller disposed on the light guide plate and includes a plurality of prism patterns overlapping at least a partial area of the active area; and a display panel disposed on the second light controller and displays an image using light provided from the first light source unit or the second light source unit.

Other detailed matters of the example embodiments are included in the detailed description and the drawings.

### Advantageous Effects

According to the present disclosure, some of a plurality of light source units disposed below a display panel is controlled to emit light according to a driving mode to control both a first area and a second area as a wide field-of-view mode in a first mode and control a first area as a wide field-of-view mode and a second area as a narrow field-of-view mode in a second mode.

According to the present disclosure, light provided to the display panel is shifted toward the second area so as not to allow an image displayed in the second area to be visible to a user located in the first area, thereby effectively controlling the viewing angle in the second mode.

According to the present disclosure, a prism pattern which shifts light provided to a display panel toward a second area is disposed in the entire active area so that a manufacturing process of the prism pattern may be further simplified.

The effects according to the present disclosure are not limited to the contents exemplified above, and more various effects are included in the present specification.

### BRIEF DESCRIPTION OF THE DRAWINGS

FIG. 1 is an example view of a display device according to an example embodiment of the present disclosure.

FIG. 2 is an exploded perspective view of a display device according to an example embodiment of the present disclosure.

FIG. 3 is a view illustrating an example of a display panel included in a display device according to an example embodiment of the present disclosure.

FIG. 4a is a side view schematically illustrating an example of a first light controller included in a display device of FIG. 2.

FIG. 4b is an enlarged view illustrating an example of a part EA1 of FIG. 4a.

FIG. 5a is a side view schematically illustrating another example of a first light controller included in a display device of FIG. 2.

FIG. 5b is an enlarged view illustrating an example of a part EA2 of FIG. 5a.

FIG. 6 is a side view schematically illustrating still another example of a first light controller included in a display device of FIG. 2.

FIG. 7 is a side view schematically illustrating still another example of a first light controller included in a display device of FIG. 2.

FIG. 8a is a side view schematically illustrating still another example of a first light controller included in a display device of FIG. 2.

FIG. 8b is an enlarged view illustrating an example of a part EA3 of FIG. 8a.

FIG. 9 is a side view schematically illustrating still another example of a first light controller included in a display device of FIG. 2.

FIG. 10 is a side view of a display device according to an example embodiment of the present disclosure.

FIG. 11 is a side view illustrating an example of a second light controller included in a display device of FIG. 10.

FIGS. 12a to 12d are graphs for explaining an example of a prism pattern included in a second light controller of FIG. 11.

FIG. 13 is a side view of a display device according to another example embodiment of the present disclosure.

FIG. 14 is an exploded perspective view of a display device according to still another example embodiment of the present disclosure.

FIG. 15 is a side view schematically illustrating an example of a light guide plate included in a display device of FIG. 14.

FIG. 16 is a rear view schematically illustrating an example of a light guide plate included in a display device of FIG. 14.

FIG. 17 is a side view of a display device according to still another example embodiment of the present disclosure.

FIG. 18 is a rear view schematically illustrating another example of a light guide plate included in a display device of FIG. 15.

### MODES OF PRACTICE

Advantages and characteristics of the present disclosure and a method of achieving the advantages and characteristics will be clear by referring to example embodiments described below in detail together with the accompanying drawings. However, the present disclosure is not limited to the example embodiments disclosed herein but will be implemented in various forms. The example embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the example embodiments of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including”, “having”, and “consist of” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the specification.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, a display device according to example embodiments of the present disclosure will be described in detail with reference to accompanying drawings.

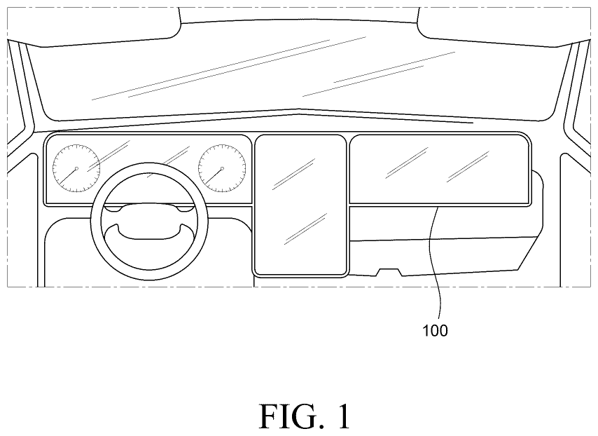

FIG. 1 is an example view of a display device according to an example embodiment of the present disclosure.

Referring to FIG. 1, the display device 100 may be disposed in at least a part of a dash board of a vehicle. The dash board of the vehicle may include a configuration disposed in a front surface of front seats (for example, a driver seat and a front passenger seat) of the vehicle. For example, on the dash board of the vehicle, an input configuration for manipulating various functions (for example, an air-conditioner, an audio system, or a navigation system) in the vehicle may be disposed.

The display device 100 is disposed on the dash board of the vehicle to operate as an input unit which manipulates at least some of various functions of the vehicle. The display device 100 may provide various information related to the vehicle, for example, operation information of the vehicle (for example, a current speed of the vehicle, a remaining fuel amount, or a mileage) or information about parts of the vehicle (for example, a damage level of a vehicle tire).

The display device 100 may be disposed across the driver seat and the front passenger seat disposed in the front seats of the vehicle. A user of the display device 100 may include a driver of the vehicle and a passenger riding on the front passenger seat. Both the vehicle driver and the passenger may use the display device 100.

Only a part of the display device 100 may be illustrated in FIG. 1. The display device 100 illustrated in FIG. 1 may represent a display panel, among various configurations included in the display device 100. Specifically, for example, the display device 100 illustrated in FIG. 1 may represent at least a part of an active area and a non-active area of the display panel. Among the configurations of the display device 100, configurations other than the parts illustrated in FIG. 1 may be mounted inside the vehicle (or at least a part of the inside of the vehicle).

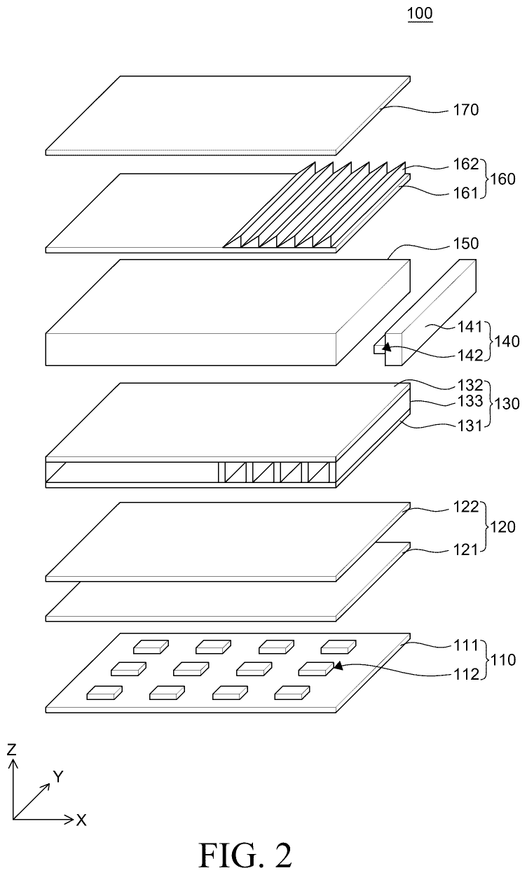

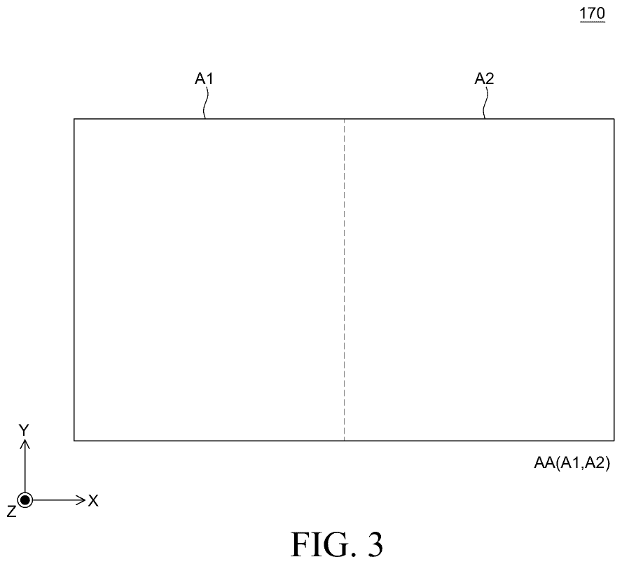

FIG. 2 is an exploded perspective view of a display device according to an example embodiment of the present disclosure. FIG. 3 is a view illustrating an example of a display panel of a display device according to an example embodiment of the present disclosure.

In the meantime, for the convenience of description, hereinafter, a horizontal direction on the plain is illustrated as a first direction X and a vertical direction on the plane is illustrated as a second direction Y. Further, a normal direction of a plane defined by the first direction X and the second direction Y, for example, a thickness direction of the display device 100 may be defined as a third direction Z.

Referring to FIG. 2, the display device 100 according to the example embodiment of the present disclosure may include a first light source unit 110, at least one optical sheet 120, a first light controller 130, a second light source unit 140, a light guide plate 150, a second light controller 160, and a display panel 170.

The display panel 170 may generate an image to be provided to a user using light provided from a light source unit disposed therebelow. For example, the display panel 170 adjusts a transmittance for light provided from the first light source unit 110 and/or the second light source unit 140 disposed therebelow to display an image.

As the display panel 170, a liquid crystal display panel may be applied. For example, the display panel 170 may include a bottom substrate, a top substrate which is opposite to the bottom substrate, and a liquid crystal layer disposed between the bottom substrate and the top substrate. Here, the liquid crystal layer may be driven by a vertical field driving method, such as a twisted nematic (TN) mode and a vertical alignment (VA) mode, or a horizontal field driving method, such as an in-plane switching (IPS) mode and a fringe field switching (FFS) mode, but is not limited thereto.

The display panel 170 may include an active area in which an image is displayed and a non-active area which encloses the active area.

The active area of the display panel 170 may be partitioned into a plurality of areas. In other words, the active area may include a plurality of areas.

For example, further referring to FIG. 3, the active area AA of the display panel 170 may include a plurality of areas A1 and A2 disposed along the first direction X. For example, the active area AA may include a first area A1 and a second area A2 which is adjacent to the first area A1 in the first direction X.

According to the example embodiment, respective areas A1 and A2 of the display panel 170 are disposed across a driver seat and a front passenger seat disposed in front seats of the vehicle which have been described with reference to FIG. 1 to provide various information to a driver and a passenger of the vehicle. The respective areas A1 and A2 of the display panel 170 may display different information images to the user. For example, the first area A1 of the display panel 170 includes an area provided to the driver seat disposed on the front seat of the vehicle and/or an area provided between the driver seat and the front passenger seat, for example, a CID area to provide information such as a driving speed, RPM, an engine temperature, and a fuel amount. The second area A2 of the display panel 170 is an area provided to the front passenger seat disposed on the front seat of the vehicle, for example, a CDD area to provide entertainment functions and seat information for the passenger sitting in the front passenger seat. However, such area division is for the convenience of description and the first area A1 and the second area A2 in the display panel 170 may be defined in various ways depending on the design.

In the meantime, when the display panel 170 is used for the vehicle which has been described with reference to FIG. 1, a field of view of at least some areas of the plurality of areas A1 and A2 included in the display panel 170 needs to be restricted according to the user's request. For example, images displayed in the second area A2 which provides the entertainment function and the seat information for the passenger sitting on the front passenger seat may interrupt the driving of the driver. Accordingly, according to the user's request, the field of view of the image displayed in the second area A2 needs to be restricted.

For example, according to the driving mode of the display device 100, in the first mode, all the plurality of areas A1 and A2 of the display panel 170 are controlled in a wide field-of-view mode (share mode) to display an image. In the second mode, at least some areas of the plurality of areas A1 and A2 of the display panel 170, for example, the second area A2 is controlled in a narrow field-of-view mode (private mode) to display an image. To this end, the display device 100 controls whether to allow the second light source unit 140 disposed on the top, among the plurality of light source units 110 and 140 disposed below the display panel 170, to emit light, to control the display panel 170 in the first mode or the second mode.

Referring to FIG. 2, a first light source unit 110, at least one optical sheet 120, a first light controller 130, a second light source unit 140, a light guide plate 150, and a second light controller 160 may be disposed below the display panel 170.

The first light source unit 110 may generate light and provide the generated light to the third direction Z, for example, toward the optical sheet 120. The first light source unit 110 may be disposed below the optical sheet 120. For example, the first light source unit 110 may be a direct type backlight assembly.

The first light source unit 110 may include a first circuit board 111 and a plurality of first light sources 112 disposed on the first circuit board 111.

The first circuit board 111 may include a driving circuit which drives the plurality of first light sources 112. The driving circuit of the first circuit board 111 may generate an electrical signal to drive the plurality of first light sources 112 and supply the electrical signal to the plurality of first light sources 112. However, the present disclosure is not limited thereto and the driving circuit may be disposed at the outside of the first circuit board 111.

The plurality of first light sources 112 may be mounted on the first circuit board 111. For example, the plurality of first light sources 112 is disposed on the first circuit board 111 to be spaced apart from each other along the first direction X and the second direction Y to be mounted on a top surface which is one surface of the first circuit board 111. For example, the plurality of first light sources 112 may be mounted on the first circuit board 111 in a matrix, but is not limited thereto.

Each of the plurality of first light sources 112 may be formed to emit white light, but is not limited thereto and each of the plurality of first light sources 112 may be formed to emit light with any one wavelength of red, green, and blue.

As the plurality of first light sources 112, a light emission diode (LED), a cold cathode fluorescent lamp (CCFL), or an external electrode fluorescent lamp may be used, but it is not limited thereto.

At least one optical sheet 120 may be disposed on the first light source unit 110. On the first light source unit 110, a plurality of optical sheets which diffuses or condenses light incident from the first light source unit 110 may be included.

For example, the optical sheet 120 may include a first optical sheet 121 and a second optical sheet 122. The first optical sheet 121 diffuses light provided from the first light source unit 110 and allows light to travel upwardly, for example, in the third direction Z. For example, the first optical sheet 121 may be a diffusion sheet. The second optical sheet 122 condenses light which has passed through the first optical sheet 121 to allow light to travel upwardly, for example, in the third direction Z. For example, the second optical sheet 122 may be a prism sheet.

However, the present disclosure is not limited thereto and the optical sheet 120 may further include another optical sheet, in addition to the first optical sheet 121 and the second optical sheet 122. For example, the optical sheet 120 may further include a luminance improvement sheet, such as a protective sheet or a dual brightness enhancement film, or include a composite optical sheet in which the diffusion sheet and the prism sheet are integrated, instead of the first optical sheet 121 and the second optical sheet 122.

The first light controller 130 may be disposed on the optical sheet 120.

The first light controller 130 may control a viewing angle of light provided from the bottom. For example, the first light controller 130 may restrict a viewing angle or an emission angle in the first direction X, of light which is emitted from the first light source unit 110 to pass through the optical sheet 120 and travel in the third direction Z which is perpendicular to the active area AA. That is, the first light controller 130 may reduce or narrow a profile of light which is emitted from the first light source unit 110 to be incident into the first light controller 130, in the first direction X. In this case, a viewing angle of the first direction X of an image which is displayed by the light may be reduced.

To this end, the first light controller 130 may include a first support member 131, a second support member 132 which is opposite to the first support member 131, and a plurality of partitions 133 which is disposed between the first support member 131 and the second support member 132. In the meantime, the term partition used in the present disclosure, is used for the convenience of description and may be defined as a term “louver” or a term “viewing angle control pattern”, instead of the partition.

Each of the plurality of partitions 133 extends between the first support member 131 and the second support member 132 in the second direction Y and may be disposed to be spaced apart from each other along the first direction X. In this case, for example, a profile of light which is incident to the first light controller 130, for example, to an area spaced between the plurality of partitions 133, is narrowed in the first direction X, by the plurality of partitions 133 disposed to be spaced apart from each other. Most of light which are restricted in the front direction, for example, in the third direction Z, may be provided to the display panel 170.

Accordingly, in an area in which the plurality of partitions 133 of the first light controller 130 is disposed, the light may be provided in a first range and in an area in which the plurality of partitions 133 of the first light controller 130 is not disposed, the light may be provided in a second range which is larger than the first range. Accordingly, in the case of the image which is displayed by light emitted from the first light source unit 110, in an area of the active area AA overlapping an area in which the plurality of partitions 133 of the first light controller 130 is disposed, the image may be displayed at the second viewing angle. In an area overlapping the area in which the plurality of partitions 133 is not disposed, the image may be displayed at the first viewing angle. The first viewing angle may be larger than the second viewing angle. For example, the first viewing angle may be defined as a wide viewing angle and the second viewing angle may be defined as a narrow viewing angle.

Further, the first light controller 130 may control the viewing angle of the image which is displayed by light emitted from the first light source unit 110 to be different in each area. For example, the first light controller 130 may control a viewing angle of light which is provided from the bottom to travel in the third direction Z in each area of the active area AA. For example, the first light controller 130 may control a viewing angle of the image which is displayed by light emitted from the first light source unit 110 in the second area A2 of the active area AA.

In this case, the plurality of partitions 133 may be disposed in an area overlapping the second area A2. Accordingly, in the case of the image displayed by light emitted from the first light source unit 110, in the second area A2 overlapping an area in which the plurality of partitions 133 is disposed, the viewing angle is controlled to the second viewing angle to display an image. In the other area, for example, in the first area A1, the viewing angle is not controlled and the image may be displayed at the first viewing angle.

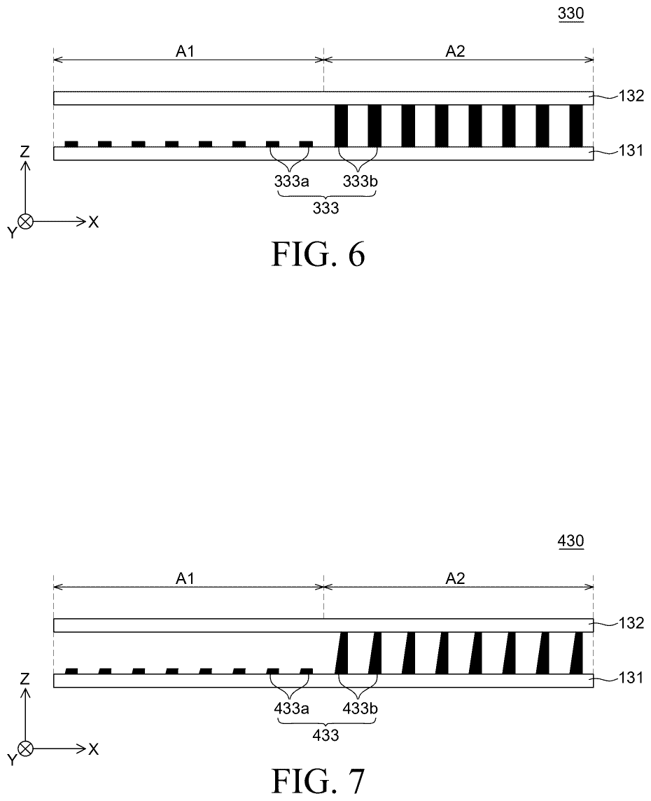

However, this is merely illustrative and the area in which the partition 133 is disposed is not limited thereto. For example, the plurality of partitions 133 may be disposed on the entire area overlapping the active area AA. This will be described in detail below with reference to FIGS. 6 to 9.

The second light source unit 140 and the light guide plate 150 may be disposed on the first light controller 130.

The second light source unit 140 may generate light and provide the generated light to the light guide plate 150. The second light source unit 140 may be disposed on a side surface of the light guide plate 150. For example, the second light source unit 140 may be an edge type backlight assembly.

The second light source unit 140 may include a second circuit board 141 and a plurality of second light sources 142 disposed on the second circuit board 141.

The second circuit board 141 may include a driving circuit which drives the plurality of second light sources 142. The driving circuit of the second circuit board 141 may generate an electrical signal to drive the plurality of second light sources 142 and supply the electrical signal to the plurality of second light sources 142. However, the present disclosure is not limited thereto and the driving circuit may be disposed at the outside of the second circuit board 141.

The second circuit board 141 may be disposed on a side surface of the light guide plate 150. That is, the second circuit board 141 may be disposed to be parallel to the light guide plate 150. For example, the second circuit board 141 may have a shape which corresponds to one short side of the light guide plate 150 to extend along a length direction of the short side, for example, along the second direction Y. However, the present disclosure is not limited thereto and the second circuit board 141 may be disposed so as to correspond to one long side of the light guide plate 150.

Further, the plurality of second light sources 142 may be mounted on the second circuit board 141. For example, the plurality of second light sources 142 is disposed on the second circuit board 141 to be spaced apart from each other along the second direction Y to be mounted on a top surface which is one surface of the second circuit board 141.

Each of the plurality of second light sources 142 may be formed to emit white light, but is not limited thereto and each of the plurality of second light sources 142 may be formed to emit light with any one wavelength of red, green, and blue.

As the plurality of second light sources 142, a light emission diode (LED), a cold cathode fluorescent lamp (CCFL), or an external electrode fluorescent lamp may be used, but it is not limited thereto.

The light guide plate 150 may be disposed on the first light controller 130 and may be disposed on a side portion of the second light source unit 140. For example, the light guide plate 150 may be disposed on substantially the same plane as the second light source unit 140.

The light guide plate 150 may be formed of a material including glass, quartz, or polymer having transparency, to efficiently guide the light. For example, the polymer may be formed of a material having a predetermined refractive index, such as acrylic resin including polymethylmethacrylate (PMMA) or polycarbonate (PC).

The light guide plate 150 guides light provided from the second light source unit 140 to allow the light to travel in a direction toward the display panel 170, for example, in the third direction Z. For example, light which is incident from the second light source unit 140, through a side surface on which the second light source unit 140 is disposed, may change the traveling direction to the third direction Z which is directed to the display panel 170, by total reflection, while traveling in the light guide plate 150. Therefore, a uniform surface light source may be provided toward the display panel 170.

Further, the light which is provided via the optical sheet 120 and the first light controller 130 from the first light source unit 110 may travel to the third direction Z which is directed to the display panel 170 by means of the light guide plate 150.

In the meantime, as described above, the driving mode of the display device 100 may be controlled depending on whether the second light source 142 included in the second light source unit 140 emits light.

For example, in the first mode, all the plurality of first light sources 112 of the first light source unit 110 and the plurality of second light sources 142 of the second light source unit 140 may emit light. In this case, even though in at least a partial area of the active area AA, for example, in an area overlapping the second area A2, a viewing angle of light emitted from the first light source unit 110 is controlled by the first light controller 130, light emitted from the second light source unit 140 travels by the light guide plate 150 in the third direction Z which is directed to the display panel 170 to be provided in the entire active area AA. Therefore, the image may be displayed at the first viewing angle in all the plurality of areas A1 and A2 of the display panel 170. Accordingly, in the first mode, the image may be displayed in a wide field-of-view mode (share mode) in the entire active area AA, for example, in both the first area A1 and the second area A2.

Further, in the second mode, the plurality of first light sources 112 of the first light source unit 110 may emit light and the plurality of second light sources 142 of the second light source unit 140 may not emit light. Therefore, an image which is displayed by the display panel 170 in the second mode may be implemented only by light provided from the first light source unit 110. In this case, in an area of the active area AA which overlaps the second area A2, the viewing angle of the light emitted from the first light source unit 110 is controlled by the first light controller 130. Therefore, in the first area A1 of the display panel 170, the image may be displayed at the first viewing angle and in the second area A2 of the display panel 170, the image may be displayed at the second viewing angle. Accordingly, in the second mode, the image may be displayed in the wide field-of-view mode (share mode) in the first area A1 of the active area AA and the image may be displayed in the narrow field-of-view mode (private mode) in the second area A2 of the active area AA.

As described above, the display device 100 according to the example embodiment of the present disclosure controls whether to allow the second light source unit 140 disposed on the top, among the plurality of light source units 110 and 140 disposed below the display panel 170, to emit light, to control the display panel 170 in the first mode or the second mode.

The second light controller 160 may be disposed on the light guide plate 150.

The second light controller 160 may control a profile of light provided from the light guide plate 150. For example, the second light controller 160 may shift a profile of light which is provided from the light guide plate 150 to travel to the display panel 170, for example, the traveling direction of the light to the first direction X which is directed to the second area A2.

To this end, the second light controller 160 may include a base layer 161 and a plurality of prism patterns 162 disposed on the base layer 161. For example, the plurality of prism patterns 162 may be disposed in an area overlapping the second area A2. However, this is merely illustrative and the area in which the prism pattern 162 is disposed is not limited thereto. For example, the plurality of prism patterns 162 may be disposed in the entire area overlapping the active area AA.

Each of the plurality of prism patterns 162 extends to the second direction Y on the base layer 161 and may be disposed along the first direction X.

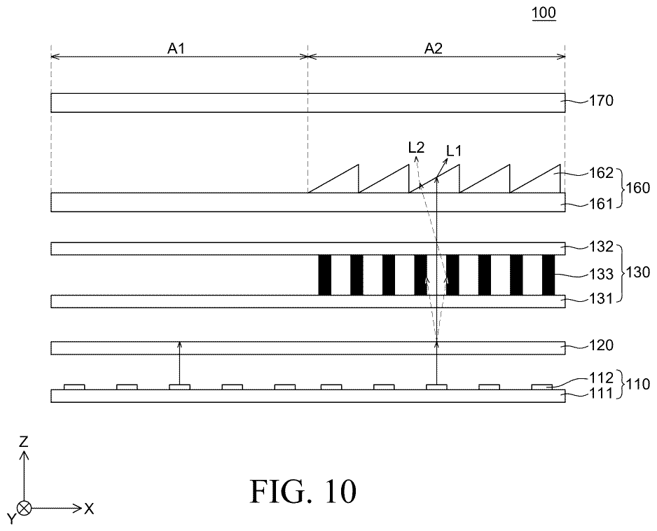

Each of the plurality of prism patterns 162 may have an asymmetric triangular prism shape. Accordingly, a cross-sectional shape of each of the plurality of prism patterns 162 may be a triangular shape. For example, on the side surface of the display device 100, each of the plurality of prism patterns 162 may have an isosceles triangular shape. In this case, when light which is incident to the second light controller 160, for example, to each of the plurality of prism patterns 162 travels from the inside of the prism pattern 162 to the outside, the light is refracted at the boundary of the inside and the outside of the prism pattern 162 according to the refractive index difference of the inside and the outside of the prism pattern 162. Accordingly, the profile of the light may be shifted. For example, if the refractive index of the inside of the prism pattern 162 is larger than the refractive index of the outside, the profile of the light may be shifted to the first direction X which is directed to the second area A2. Accordingly, in the above-described second mode, the viewing angle of the second area A2 may be more effectively controlled. Further, light which passes through the second light controller 160 is shifted to the first direction X which is directed to the second area A2 so that the viewing angle in the second area A2 may be improved. This will be described in detail below with reference to FIGS. 10 to 13.

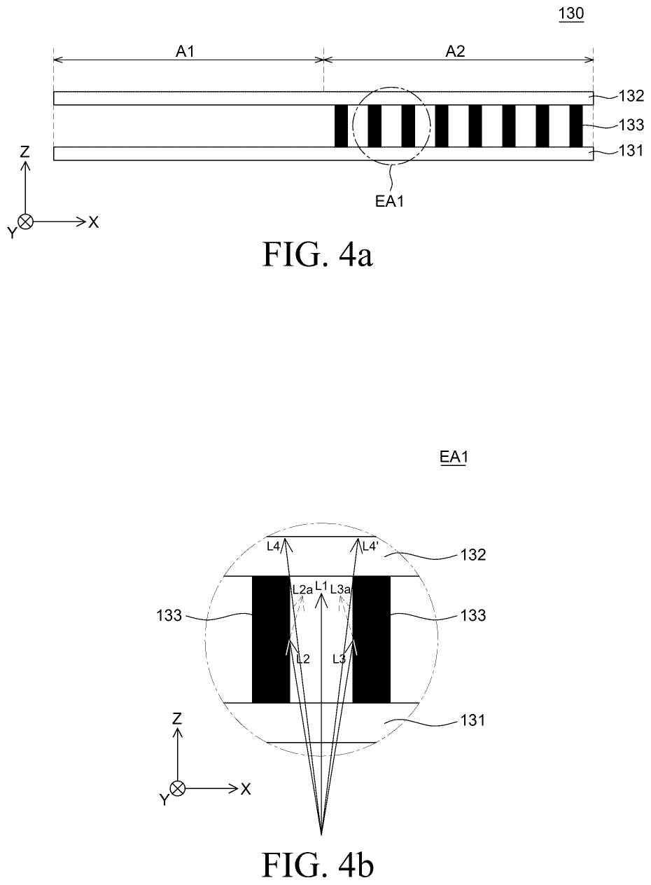

Hereinafter, the first light controller 130 of the display device 100 according to the example embodiment of the present disclosure will be described in more detail with reference to FIGS. 4a to 9 and the second light controller 160 of the display device 100 according to the example embodiment of the present disclosure will be described in more detail with reference to FIGS. 10 to 13.

FIG. 4a is a side view schematically illustrating an example of a first light controller included in a display device of FIG. 2. FIG. 4b is an enlarged view illustrating an example of a part EA1 of FIG. 4a.

In the meantime, the first light controller 130 illustrated in FIG. 4a represents an example embodiment of the first light controller 130 included in the display device 100 which has been described with reference to FIG. 2.

Referring to FIGS. 2 and 4a, the first light controller 130 includes a first support member 131, a second support member 132 which is opposite to the first support member 131, and a plurality of partitions 133 disposed between the first support member 131 and the second support member 132. By doing this, the first light controller may control a viewing angle or an emission angle according to the first direction X of light which travels toward the third direction Z which is perpendicular to the active area AA.

The first support member 131 and the second support member 132 may be disposed to be spaced apart from each other with the partition 133 therebetween. The first support member 131 is disposed below the plurality of partitions 133 to support the plurality of partitions 133 and the second support member 132 is disposed above the plurality of partitions 133 to support the plurality of partitions 133. However, it is not limited thereto and bottom surfaces of the plurality of partitions 133 may be in contact with the first support member 131, but top surfaces of the plurality of partitions 133 may be spaced apart from the second support member 132.

The first support member 131 and the second support member 132 include a transparent material to allow light to pass therethrough. For example, each of the first support member 131 and the second support member 132 may include a plastic material. For example, each of the first support member 131 and the second support member 132 may include polycarbonate. However, the material of each of the first support member 131 and the second support member 132 is not limited thereto. According to the example embodiment, each of the first support member 131 and the second support member 132 may include polymer, such as polystyrene, polyvinyl alcohol, polymethyl methacrylate, polyethersulfone, polyacrylate, polyetherimide, polyethylene naphthalate, polyethylene terephthalate, polyphenylene sulfide, polyarylate, or polyimide.

The plurality of partitions 133 may be disposed between the first support member 131 and the second support member 132. In the meantime, each of the plurality of partitions 133 may be coupled to the first support member 131 and the second support member 132 by means of a transparent adhesive, but is not limited thereto.

Each of the plurality of partitions 133 extends along the second direction Y and may be disposed to be spaced apart from each other along the first direction X. Accordingly, a space may be formed between the plurality of partitions 133. Such a space may be filled with air or a transparent insulating material, but is not limited thereto.

In the meantime, an interval along the first direction X, between two adjacent partitions 133, among the plurality of partitions 133, may be determined by comprehensively considering a thickness of the first light controller 130, an emission angle of light emitted from the first light controller 130, and a distance between the first light controller 130 and the display panel 170. By doing this, the image displayed by the light provided from the first light source unit 110 is displayed on the second area A2 at the second viewing angle.

Each of the plurality of partitions 133 may include a light absorption material or may be coated with a light absorbing agent to absorb light entering from the outside. For example, each of the plurality of partitions 133 may include a carbon-based black pigment. However, a material of the plurality of partitions 133 is not limited thereto. Each of the plurality of partitions 133 may include at least any one of titanium (Ti), tungsten (W), chromium (Cr), molybdenum (Mo), an alloy of molybdenum (Mo) and titanium (Ti) (MoTi), vanadium (V), niobium (Nb), silicon nitride (SiN), titanium nitride (TiN), silicon carbide (SiC), tantalum (Ta), manganese (Mn), cobalt (Co), nickel (Ni), copper oxide (CuO), aluminum oxide (Al2O3), iron oxide (Fe3O4), and tantalum oxide (Ta2O5) having a high light absorptance or may include an organic material having a high light absorptance.

Further, each of the plurality of partitions 133 may have a rectangular shape on a side surface. For example, each of the plurality of partitions 133 may have a rectangular shape as seen from a plane defined by the first direction X and the third direction Z. Accordingly, the top surface and the bottom surface of each of the plurality of partitions 133 may be parallel to the support members 131 and 132 and both side surfaces of each of the plurality of partitions 133 may be perpendicular to the support members 131 and 132. For example, both side surfaces of each of the plurality of partitions 133 may be parallel to the third direction Z which is perpendicular to each of the support members 131 and 132.

An emission angle in the first direction X of light which is emitted from the first light controller 130 may be restricted by the plurality of partitions 133. In the meantime, according to the present disclosure, an emission angle may refer to an angle formed by a traveling direction of light emitted from the first light controller 130 and the third direction Z on the plane defined by the first direction X and the third direction Z.

To be more specific, further referring to FIG. 4b, a profile of light provided from the bottom of the first light controller 130, for example, a profile of light provided from the first light source unit 110 is reduced or narrowed along the first direction X, by the first light controller 130 so that the emission angle in the first direction X of the corresponding light may be restricted.

For example, among light provided from the bottom of the first light controller 130, first light L1 having a light path formed in the third direction Z which is a vertical direction, between two separated partitions 133, is not blocked by the partition 133, but may be emitted to the outside, that is, the upward direction of the first light controller 130.

Further, among light provided from the bottom of the first light controller 130, light which passes through the upper end inside of two separated partitions 133, that is, light between fourth light L4 and fourth′ light L4′ may be emitted to an upward direction of the first light controller 130.

However, when a light path is formed in a direction having a predetermined angle along the first direction X with respect to the third direction Z between two separated partitions 133 and the partition 133 is located on the light path, among light provided from the bottom of the first light controller 130, at least some of light may be blocked by the partition 133. That is, light provided from the bottom of the first light controller 130 at an angle larger than an incident angle of the fourth light L4 and fourth′ light LA′ is blocked by the plurality of partitions 133 so as not to be emitted to an upward direction of the first light controller 130. For example, at least some of second light L2 and the third light L3 provided from the bottom of the first light controller 130 are absorbed by the partition 133 and are not emitted to the outside.

In the meantime, in the case of light with a light path on which the partition 133 is located, each of the plurality of partitions 133 includes a light absorption material or is coated with the light absorption agent so that most light is absorbed by the partition 133. However, the remaining light which is not absorbed by the partition 133 is totally reflected from the partition 133 to be emitted to the outside. For example, second light L2a of the second light L2 which is not absorbed by the partition 133 and third light L3a of the third light L3 which is not absorbed by the partition 133 are totally reflected from the partition 133 to be emitted to the outside.

Referring to FIG. 4a, a height of each of the plurality of partitions 133 may be substantially the same as a length of a space between the first support member 131 and the second support member 132 along the third direction Z. However, the present disclosure is not limited thereto and the height of each of the plurality of partitions 133 along the third direction Z may be smaller than a length of the space between the first support member 131 and the second support member 132 along the third direction Z. In the meantime, in the present disclosure, the height may refer to a length or a distance along the third direction Z.

Further, the plurality of partitions 133 is disposed on the second area A2 and may not be disposed on the first area A1. In this case, as described above, in the second area A2 in which the plurality of partitions 133 is disposed, an emission angle of the light in the first direction X is restricted to provide the light in the first range. Further, in the first area A1 in which the plurality of partitions 133 is not disposed, an emission angle of the light is not restricted to provide the light in the second range which is larger than the first range. Accordingly, in the case of an image which is displayed by light emitted from the first light source unit 110 disposed below the first light controller 130, in the second area A2 of the active area AA overlapping an area in which the plurality of partitions 133 is disposed, the image may be displayed at the second viewing angle, for example, at a narrow viewing angle. Further, in the first area A1 overlapping an area in which the plurality of partitions 133 is not disposed, the image may be displayed at the first viewing angle, for example, at a wide viewing angle.

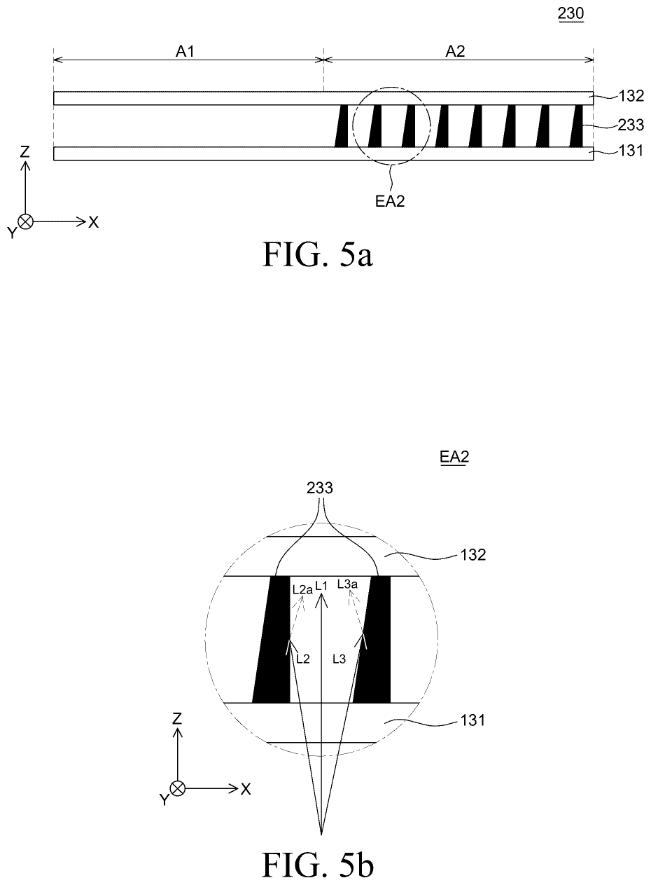

FIG. 5a is a side view schematically illustrating another example of a first light controller included in a display device of FIG. 2.

FIG. 5b is an enlarged view illustrating an example of a part EA2 of FIG. 5a.

In the meantime, a first light controller 230 illustrated in FIG. 5a represents another example embodiment of the first light controller 130 included in the display device 100 which has been described with reference to FIG. 2.

Further, FIGS. 5a and 5b illustrate a modified embodiment of the example embodiment of FIGS. 4a and 4b with regard to a shape of a plurality of partitions 233 included in the first light controller 230. Accordingly, in FIGS. 5a and 5b, in order to avoid a redundant description, differences from the above-described example embodiments will be mainly described.

Referring to FIGS. 2 and 5a, the first light controller 230 includes a first support member 131, a second support member 132 which is opposite to the first support member 131, and a plurality of partitions 233 disposed between the first support member 131 and the second support member 132. By doing this, the first light controller may control a viewing angle or an emission angle according to the first direction X of light which travels toward the third direction Z which is perpendicular to the active area AA.

The plurality of partitions 233 may be disposed between the first support member 131 and the second support member 132. For example, each of the plurality of partitions 233 extends along the second direction Y and may be disposed to be spaced apart from each other along the first direction X. Accordingly, a space may be formed between the plurality of partitions 233.

Each of the plurality of partitions 233 may have a trapezoidal shape on a side surface. For example, each of the plurality of partitions 233 may have a trapezoidal shape as seen from a plane defined by the first direction X and the third direction Z. Accordingly, the top surface and the bottom surface of each of the plurality of partitions 233 may be parallel to the support members 131 and 132 and one side surface of each of the plurality of partitions 233 may be perpendicular to the support members 131 and 132 and the other one side surface of each of the plurality of partitions 233 may have a plane inclined from the support members 131 and 132 at a predetermined angle. For example, one side surface located closer to the first direction X, between both side surfaces of each of the plurality of partitions 233, may be parallel to the third direction Z which is perpendicular to each of the support members 131 and 132. The other side surface located in the opposite direction to the first direction X, between both side surfaces of each of the plurality of partitions 233, may have an inclined plane at a predetermined angle with respect to the third direction Z.

Accordingly, an emission angle of light emitted from the first light controller 230 in the first direction X may be more effectively restricted by the plurality of partitions 233 having a trapezoidal shape on the side surface.

To be more specific, further referring to FIG. 5b, a profile of light provided from the bottom of the first light controller 230, for example, a profile of light supplied from the first light source unit 110 is reduced or narrowed along the first direction X, by the first light controller 230 so that the emission angle of the corresponding light in the first direction X may be restricted.

Specifically, among light provided from the bottom of the first light controller 230, when a light path is formed in a direction having a predetermined angle along the first direction X with respect to the third direction Z, between two separated partitions 233 and the inclined side surface of the partition 233 is located on the light path, if the remaining light of light which is not absorbed by the partition 233 is totally reflected, the light may be guided more toward the third direction Z which is a vertical direction, as compared with the case when the light is totally reflected by a vertical side surface of the partition 233. For example, at least a part of the second light L2 which is provided from the bottom of the first light controller 230 to travel to the vertical side surface of the partition 233 may be absorbed by the partition 233 and second light L2a which is not absorbed by the partition 233 may be totally reflected from the vertical side surface of the partition 233. At least a part of the third light L3 which is provided from the bottom of the first light controller 230 to travel to the inclined side surface of the partition 233 may be absorbed by the partition 233 and third light L3a which is not absorbed by the partition 233 may be totally reflected from the inclined side surface of the partition 233. Here, depending on the difference in the incident angles on the vertical side surface and the inclined side surface of the partition 233, the third light L3a which is totally reflected by the inclined side surface of the partition 233 may be guided to the third direction Z which is a vertical direction more than the second light L2a which is totally reflected by the vertical side surface of the partition 233. Accordingly, more light which is directed to the display panel 170 in the second area A2 may be condensed.

Further, the third light L3a which is totally reflected by the inclined side surface of the partition 233 travels toward the opposite direction to the first direction X in which the first area A1 is located. When the third light is totally reflected, the third light is more guided to the third direction Z which is a vertical direction by the incident angle according to the inclined side surface. Accordingly, as compared with the third light L3a which is totally reflected by the vertical side surface of the partition 133 which has been described with reference to FIG. 4a, the third light L3a which is totally reflected by the inclined side surface of the partition 233 which has been described with reference to FIG. 5a, may be more shifted to the first direction X. Accordingly, in the case of the image which is displayed on the second area A2 by the light provided from the first light source unit 110, a viewing angle to the first area A1 may be more effectively restricted.

FIG. 6 is a side view schematically illustrating still another example of a first light controller included in a display device of FIG. 2.

In the meantime, a first light controller 330 illustrated in FIG. 6 represents still another example embodiment of the first light controller 130 included in the display device 100 which has been described with reference to FIG. 2.

Further, FIG. 6 illustrates a modified embodiment of the example embodiment of FIG. 4a with regard to an area in which a plurality of partitions 333 included in the first light controller 330 is disposed. Accordingly, in FIG. 6, in order to avoid a redundant description, differences from the above-described example embodiments will be mainly described.

Referring to FIGS. 2 and 6, the first light controller 330 may include a first support member 131, a second support member 132 which is opposite to the first support member 131, and a plurality of partitions 333 disposed between the first support member 131 and the second support member 132. By doing this, the first light controller may control a viewing angle or an emission angle according to the first direction X of light which travels toward the third direction Z which is perpendicular to the active area AA.

The plurality of partitions 333 may be disposed on the entire active area AA. For example, the plurality of partitions 333 may include a plurality of first partitions 333a disposed on the first area A1 and a plurality of second partitions 333b disposed on the second area A2.

The plurality of first partitions 333a may be disposed between the first support member 131 and the second support member 132 on the first area A1. For example, each of the plurality of first partitions 333a extends along the second direction Y and may be disposed to be spaced apart from each other along the first direction X. Accordingly, a space may be formed between the plurality of first partitions 333a.

The plurality of second partitions 333b may be disposed between the first support member 131 and the second support member 132 on the second area A2. For example, each of the plurality of second partitions 333b extends along the second direction Y and may be disposed to be spaced apart from each other along the first direction X. Accordingly, a space may be formed between the plurality of second partitions 333b.

Further, each of the plurality of first partitions 333a and the plurality of second partitions 333b may have a rectangular shape on the side surface. For example, each of the plurality of first partitions 333a and the plurality of second partitions 333b may have a rectangular shape as seen from a plane defined by the first direction X and the third direction Z.

A height of the first partition 333a may be different from a height of the second partition 333b. For example, the height of the first partition 333a may be smaller than the height of the second partition 333b. For example, as described with reference to FIGS. 4a and 4b, a height of each of the plurality of second partitions 333b disposed on the second area A2 is substantially equal to or smaller than the length of the space between the first support member 131 and the second support member 132 along the third direction Z. Further, the height of each of the plurality of first partitions 333a disposed on the first area A1 may be designed to have the smallest height which is available by the process.

As described above, the plurality of first partitions 333a has a very small height so that an emission angle of light which is incident to the first area A1 may not be substantially restricted. Accordingly, in the first area A1 in which the plurality of first partitions 333a is disposed, the light may be provided in the second range which is larger than the first range. Accordingly, in the case of an image which is displayed by light emitted from the first light source unit 110 disposed below the first light controller 330, in the second area A2 of the active area AA overlapping an area in which the plurality of second partitions 333b is disposed, the image may be displayed at the second viewing angle, for example, at a narrow viewing angle. Further, in the first area A1 overlapping an area in which the plurality of first partitions 333a having a very small height is disposed, the image may be displayed at the first viewing angle, for example, at a wide viewing angle.

Further, the partition is not formed only in a partial area of the active area AA, but a plurality of partitions 333 is formed in the entire area of the active area AA, during the manufacturing process of the first light controller 330 so that the manufacturing process of the first light controller 330 may be further simplified.

FIG. 7 is a side view schematically illustrating still another example of a first light controller included in a display device of FIG. 2.

In the meantime, a first light controller 430 illustrated in FIG. 7 represents still another example embodiment of the first light controller 130 included in the display device 100 which has been described with reference to FIG. 2.

Further, FIG. 7 illustrates a modified embodiment of the example embodiment of FIG. 5a with regard to an area in which a plurality of partitions 433 included in the first light controller 430 is disposed. Accordingly, in FIG. 7, in order to avoid a redundant description, differences from the above-described example embodiments will be mainly described.

Referring to FIGS. 2 and 7, the first light controller 430 may include a first support member 131, a second support member 132 which is opposite to the first support member 131, and a plurality of partitions 433 disposed between the first support member 131 and the second support member 132. By doing this, the first light controller may control a viewing angle or an emission angle according to the first direction X of light which travels toward the third direction Z which is perpendicular to the active area AA.

The plurality of partitions 433 may be disposed on the entire active area AA. For example, the plurality of partitions 433 may include a plurality of first partitions 433a disposed on the first area A1 and a plurality of second partitions 433b disposed on the second area A2.

The plurality of first partitions 433a may be disposed between the first support member 131 and the second support member 132 on the first area A1. For example, each of the plurality of first partitions 433a extends along the second direction Y and may be disposed to be spaced apart from each other along the first direction X. Accordingly, a space may be formed between the plurality of first partitions 433a.

The plurality of second partitions 433b may be disposed between the first support member 131 and the second support member 132 on the second area A2. For example, each of the plurality of second partitions 433b extends along the second direction Y and may be disposed to be spaced apart from each other along the first direction X. Accordingly, a space may be formed between the plurality of second partitions 433b.

Further, each of the plurality of first partitions 433a and the plurality of second partitions 433b may have a trapezoidal shape on the side surface. For example, each of the plurality of first partitions 433a and the plurality of second partitions 433b may have a trapezoidal shape as seen from a plane defined by the first direction X and the third direction Z.

A height of the first partition 433a may be different from a height of the second partition 433b. For example, the height of the first partition 433a may be smaller than the height of the second partition 433b. For example, a height of each of the plurality of second partitions 433b disposed on the second area A2 may be substantially equal to or smaller than the length of the space between the first support member 131 and the second support member 132 along the third direction Z. Further, the height of each of the plurality of first partitions 433a disposed on the first area A1 may be designed to have the smallest height which is available by the process.

As described above, the plurality of first partitions 433a has a very small height so that an emission angle of light which is incident to the first area A1 may not be substantially restricted. Accordingly, in the first area A1 in which the plurality of first partitions 433a is disposed, the light may be provided in the second range which is larger than the first range. Accordingly, in the case of an image which is displayed by light emitted from the first light source unit 110 disposed below the first light controller 430, in the second area A2 of the active area AA overlapping an area in which the plurality of second partitions 433b is disposed, the image may be displayed at the second viewing angle, for example, at a narrow viewing angle. Further, in the first area A1 overlapping an area in which the plurality of first partitions 433a having a very small height is disposed, the image may be displayed at the first viewing angle, for example, at a wide viewing angle.

Further, the partition is not formed only in a partial area of the active area AA, but a plurality of partitions 433 is formed in the entire area of the active area AA, during the manufacturing process of the first light controller 430 so that the manufacturing process of the first light controller 430 may be further simplified.

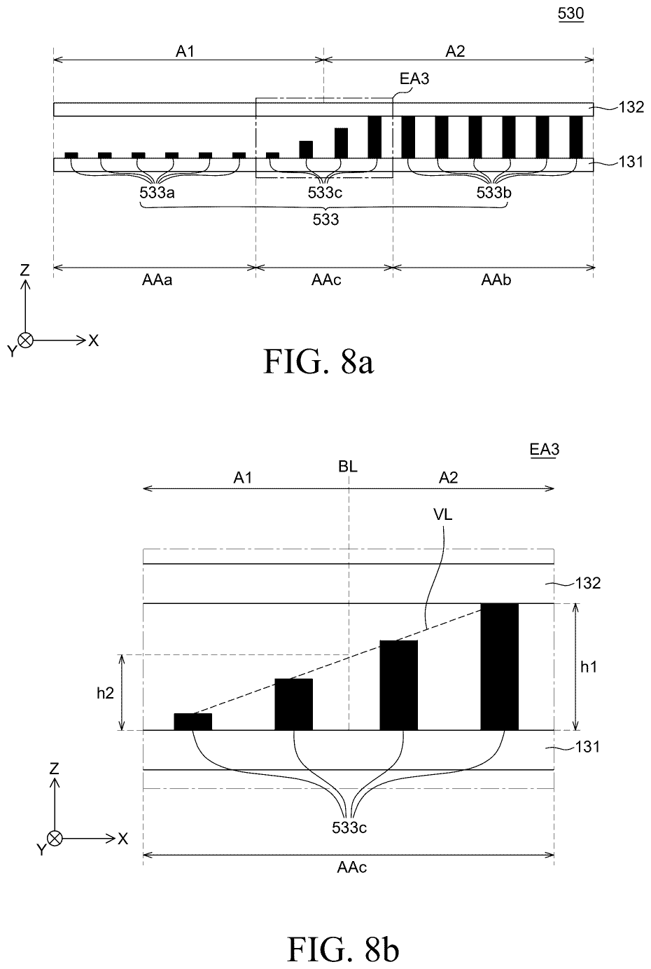

FIG. 8a is a side view schematically illustrating still another example of a first light controller included in a display device of FIG. 2.

FIG. 8b is an enlarged view illustrating an example of a part EA3 of FIG. 8a.

In the meantime, a first light controller 530 illustrated in FIG. 8a represents still another example embodiment of the first light controller 130 included in the display device 100 which has been described with reference to FIG. 2.

Further, FIG. 8a illustrates a modified embodiment of the example embodiment of FIG. 6 with regard to a height of a plurality of partitions 533 included in the first light controller 530. Accordingly, in FIGS. 8a and 8b, in order to avoid a redundant description, differences from the above-described example embodiments will be mainly described.

Referring to FIGS. 2 and 8a, the first light controller 530 may include a first support member 131, a second support member 132 which is opposite to the first support member 131, and a plurality of partitions 533 disposed between the first support member 131 and the second support member 132. By doing this, the first light controller may control a viewing angle or an emission angle according to the first direction X of light which travels toward the third direction Z which is perpendicular to the active area AA.

In the meantime, referring to FIG. 8a, the active area AA may be divided into a plurality of sub areas AAa, AAb, and AAc. For example, the active area AA may be divided into a first sub area AAa, a second sub area AAb, and a third sub area AAc. Here, the first sub area AAa may correspond to a partial area of the first area A1, the second sub area AAb may correspond to a partial area of the second area A2, and the third sub area AAc is an area which is disposed between the first sub area AAa and the second sub area AAb and includes a boundary between the first area A1 and the second area A2. The third sub area AAc may be defined as an area including an area excluding the first sub area AAa from the first area A1 and an area excluding the second sub area AAb from the second area A2.

The plurality of partitions 533 may be disposed on each sub area AAa, AAb, AAc of the active area AA. For example, the plurality of partitions 533 may include a plurality of first partitions 533a disposed on the first sub area AAa, a plurality of second partitions 533b disposed on the second sub area AAb, and a plurality of third partitions 533c disposed on the third sub area AAc.

The plurality of first partitions 533a may be disposed between the first support member 131 and the second support member 132 on the first sub area AAa. For example, each of the plurality of first partitions 533a extends along the second direction Y and may be disposed to be spaced apart from each other along the first direction X. Accordingly, a space may be formed between the plurality of first partitions 533a.

The plurality of second partitions 533b may be disposed between the first support member 131 and the second support member 132 on the second sub area AAb. For example, each of the plurality of second partitions 533b extends along the second direction Y and may be disposed to be spaced apart from each other along the first direction X. Accordingly, a space may be formed between the plurality of second partitions 533b.

The plurality of third partitions 533c may be disposed between the first support member 131 and the second support member 132 on the third sub area AAc. For example, each of the plurality of third partitions 533c extends along the second direction Y and may be disposed to be spaced apart from each other along the first direction X. Accordingly, a space may be formed between the plurality of third partitions 533c.

For example, each of the plurality of first partitions 533a, the plurality of second partitions 533b, and the plurality of third partitions 533c may have a rectangular shape on the side surface. For example, each of the plurality of first partitions 533a, the plurality of second partitions 533b, and the plurality of third partitions 533c may have a rectangular shape as seen from a plane defined by the first direction X and the third direction Z.

A height of the first partition 533a may be different from a height of the second partition 533b. For example, the height of the first partition 533a may be smaller than the height of the second partition 533b. For example, a height of each of the plurality of second partitions 533b disposed on the second sub area AAb may be substantially equal to the length of the space between the first support member 131 and the second support member 132 along the third direction Z. Further, the height of each of the plurality of first partitions 533a disposed on the first sub area AAa may be designed to have the smallest height which is available by the process.

Further, the height of the plurality of third partitions 533c may be gradually increased toward the first direction X. For example, the height of the plurality of third partitions 533c may be gradually increased from the first area A1 or the first sub area AAa to the second area A2 or the second sub area AAb. For example, a third partition 533c, among the plurality of third partitions 533c, which is the most adjacent to the first sub area AAa has the same height as the first partition 533a. A third partition 533c, among the plurality of third partitions 533c, which is the most adjacent to the second sub area AAb has the same height as the second partition 533b. The remaining third partitions 533c, among the plurality of third partitions 533c, has a height between the first partition 533a and the second partition 533b and the height may be increased toward the first direction X.

In other words, the height of the plurality of partitions 533 may be gradually increased from the vicinity of the boundary between the first area A1 and the second area A2 toward the first direction X, that is, toward the second sub area AAb. Accordingly, in the case of the image which is displayed by light which is incident to the first light controller 530, a boundary visibility according to a viewing angle difference of the respective areas A1 and A2 may be minimized in the boundary portion between the second area A2 and the first area A1. In the second area A2, a viewing angle is entirely restricted to display an image at a second viewing angle, for example, a narrow viewing angle and in the first area A1, the viewing angle is not substantially restricted to display an image at a first viewing angle, for example, a wide viewing angle.

In the meantime, the boundary between the first area A1 and the second area A2 of the active area AA may be defined in the third sub area AAc. To be more specific, further referring to FIG. 8b, on a virtual line VL connecting center points of top surfaces of the plurality of third partitions 533c, a straight line parallel to the third direction Z, with respect to a point where a height from the first support member 131 is a second height h2 which is half the first height h1 which is the height of the second partition 533b disposed on the second area A2, may be defined as the boundary line BL between the first area A1 and the second area A2. However, it is merely illustrative to divide the first area A1 and the second area A2 in the active area AA along the boundary line BL and the first area A1 and the second area A2 in the active area AA may be defined in various ways depending on the design. For example, depending on the design, on the virtual line VL connecting center points of top surfaces of the plurality of third partitions 533c, a straight line parallel to the third direction Z based on a point having a height equal to ⅔ of the first height h1 may be defined as the boundary line BL between the first area A1 and the second area A2.

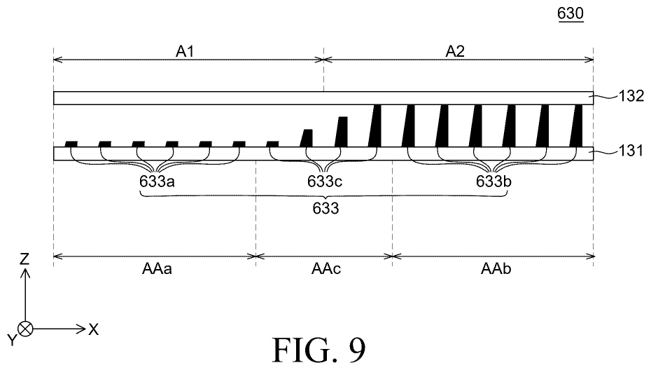

FIG. 9 is a side view schematically illustrating still another example of a first light controller included in a display device of FIG. 2.

In the meantime, a first light controller 630 illustrated in FIG. 9 represents still another example embodiment of the first light controller 130 included in the display device 100 which has been described with reference to FIG. 2.

Further, FIG. 9 illustrates a modified embodiment of the example embodiment of FIG. 7 with regard to a height of a plurality of partitions 633 included in the first light controller 630. Accordingly, in FIG. 9, in order to avoid a redundant description, differences from the above-described example embodiments will be mainly described.

Referring to FIGS. 2 and 9, the first light controller 630 may include a first support member 131, a second support member 132 which is opposite to the first support member 131, and a plurality of partitions 633 disposed between the first support member 131 and the second support member 132. By doing this, the first light controller may control a viewing angle or an emission angle according to the first direction X of light which travels toward the third direction Z which is perpendicular to the active area AA.

In the meantime, referring to FIG. 9, the active area AA may be divided into a plurality of sub areas AAa, AAb, and AAc. Here, the division of the plurality of sub areas AAa, AAb, and AAc is substantially the same as or similar to the area division which has been described with reference to FIG. 8a so that a redundant description will not be repeated.

The plurality of partitions 633 may be disposed on each sub area AAa, AAb, AAc of the active area AA. For example, the plurality of partitions 633 may include a plurality of first partitions 633a disposed on the first sub area AAa, a plurality of second partitions 633b disposed on the second sub area AAb, and a plurality of third partitions 633c disposed on the third sub area AAc.

The plurality of first partitions 633a may be disposed between the first support member 131 and the second support member 132 on the first sub area AAa. For example, each of the plurality of first partitions 633a extends along the second direction Y and may be disposed to be spaced apart from each other along the first direction X. Accordingly, a space may be formed between the plurality of first partitions 633a.

The plurality of second partitions 633b may be disposed between the first support member 131 and the second support member 132 on the second sub area AAb. For example, each of the plurality of second partitions 633b extends along the second direction Y and may be disposed to be spaced apart from each other along the first direction X. Accordingly, a space may be formed between the plurality of second partitions 633b.

The plurality of third partitions 633c may be disposed between the first support member 131 and the second support member 132 on the third sub area AAc. For example, each of the plurality of third partitions 633c extends along the second direction Y and may be disposed to be spaced apart from each other along the first direction X. Accordingly, a space may be formed between the plurality of third partitions 633c.

Further, each of the plurality of first partitions 633a, the plurality of second partitions 633b, and the plurality of third partitions 633c may have a trapezoidal shape on the side surface. For example, each of the plurality of first partitions 633a, the plurality of second partitions 633b, and the plurality of third partitions 633c may have a trapezoidal shape as seen from a plane defined by the first direction X and the third direction Z.

A height of the first partition 633a may be different from a height of the second partition 633b. For example, the height of the first partition 633a may be smaller than the height of the second partition 633b. For example, a height of each of the plurality of second partitions 633b disposed on the second sub area AAb may be substantially equal to the length of the space between the first support member 131 and the second support member 132 along the third direction Z. Further, the height of each of the plurality of first partitions 633a disposed on the first sub area AAa may be designed to have the smallest height which is available by the process.

Further, the height of the plurality of third partitions 633c may be gradually decreased toward the opposite direction to the first direction X. For example, a third partition 633c which is the most adjacent to the second sub area AAb, among the plurality of third partitions 633c, has the same height as the second partition 633b. A third partition 633c which is the most adjacent to the first sub area AAa, among the plurality of third partitions 633c, has the same height as the first partition 633a. The remaining third partitions 633c, among the plurality of third partitions 633c, has a height between the first partition 633a and the second partition 633b and the height may be decreased toward the opposite direction to the first direction X. Accordingly, in the case of the image displayed by light which is incident to the first light controller 630, the boundary visibility according to the viewing angle difference of the respective areas A1 and A2 in the boundary portion between the first area A1 and the second area A2 may be minimized.

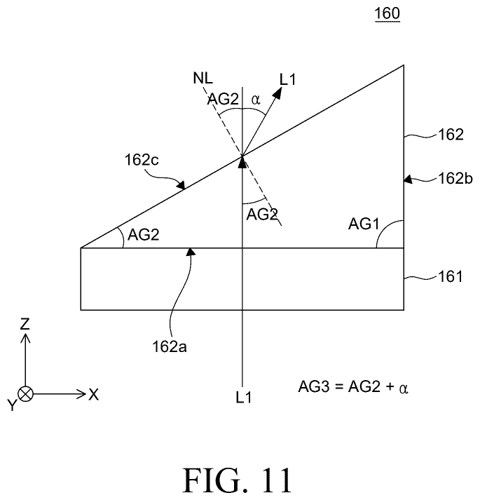

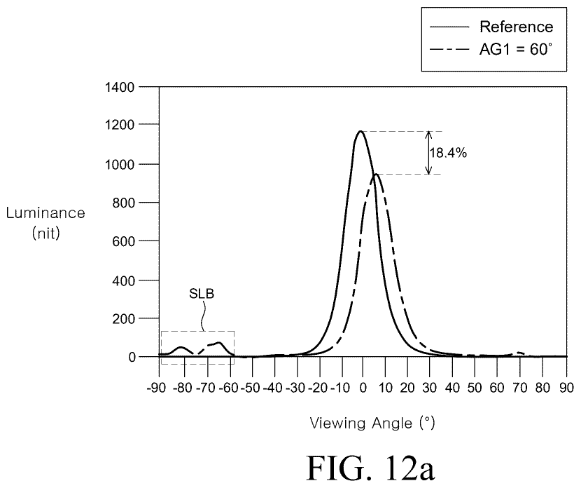

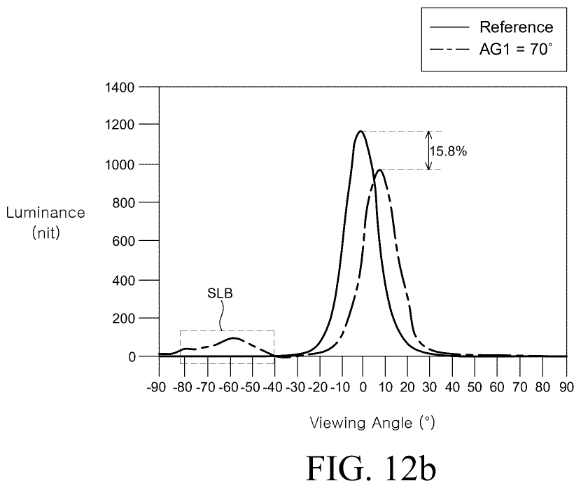

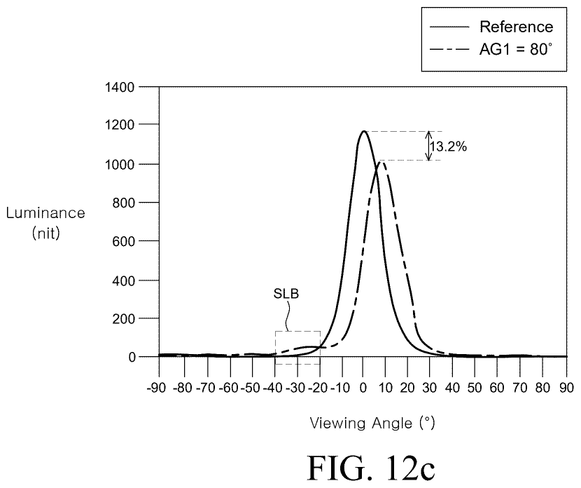

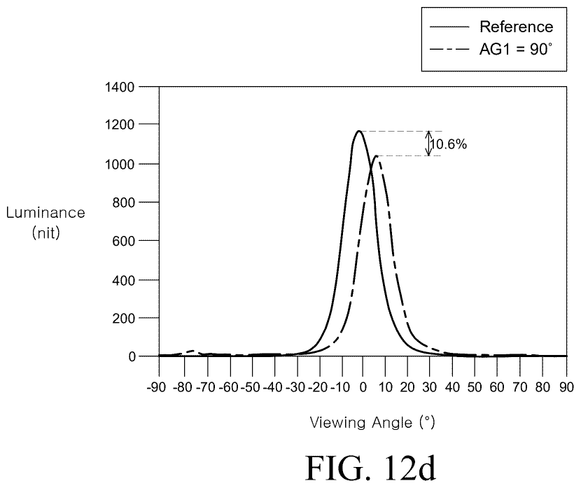

FIG. 10 is a side view of a display device according to an example embodiment of the present disclosure. FIG. 11 is a side view illustrating an example of a second light controller included in a display device of FIG. 10. FIGS. 12a to 12d are graphs for explaining an example of a prism pattern included in a second light controller of FIG. 11.

In the meantime, FIG. 10 illustrates a side view of a display device 100 which is driven in a second mode in which only a first light source unit 110 emits light, but a second light source unit 140 does not emit light. Therefore, for the convenience of description, in FIG. 10, among configurations included in the display device 100 according to the example embodiment of the present disclosure, the second light source unit 140 and the light guide plate 150 are omitted.

In the meantime, for the convenience of description, in FIG. 10, a display device 100 including a first light controller 130 according to the example embodiment which has been described with reference to FIGS. 4a and 4b, among various example embodiments of the first light controllers 130, 230, 330, 430, 530, and 630 which have been described with reference to FIGS. 4a to 9, is illustrated. However, this is merely illustrative and the display device 100 may include the first light controllers 230, 330, 430, 530, and 630 according to any one example embodiment, among various example embodiments which have been described with reference to FIGS. 5a to 9.

Referring to FIG. 10, a plurality of first light sources 112 included in the first light source unit 110 emits light to provide light to the display panel 170. For example, light which is provided from the plurality of first light sources 112 to travel to the third direction Z is diffused or condensed by means of the optical sheet 120 to be provided to the first light controller 130.

For example, first light L1 having a light path formed in the third direction Z which is a vertical direction, between two separated partitions 133 of the first light controller 130, is not blocked by the partition 133, but may be emitted to the upward direction of the first light controller 130, that is, to the third direction Z to be provided to the second light controller 160.

Further, a light path is formed between two separated partitions 133 of the first light controller 130 in a direction having a predetermined angle with respect to the third direction Z and at least a part of light with a light path on which a side wall of the partition 133 is located is absorbed by the partition 133 so as not to be emitted to the outside. The remaining part which is not absorbed by the partition 133 is totally reflected from the partition 133 to be emitted to an upward direction of the first light controller 130 to be provided to the second light controller 160. For example, most of the second light L2 is absorbed by the partition 133 and the remaining part of the second light L2 is not absorbed by the partition 133, but is totally reflected to be provided to the second light controller 160.

As described above, light which is not absorbed by the partition 133, but is totally reflected to be emitted from the first light controller 130 toward the display panel 170 may be emitted at an angle larger than an emission angle of the first light controller 130. The emission angle of the first light controller 130 is designed to allow an image displayed by light provided from the first light source unit 110 on the second area A2 as described above according to an angle totally reflected from the partition 133 to be displayed at the second viewing angle. For example, when second light L2 which is not absorbed by the partition 133, but is totally reflected, among the second light L2, is emitted at an angle larger than the designed emission angle of the first light controller 130 and is provided to the display panel 170 with a light path which is not changed, at least a part of the image which is displayed by the light provided from the first light source unit 110 on the second area A2 may be displayed at a viewing angle which is larger than the second viewing angle. For example, when the display device 100 is used for the vehicle which is described with reference to FIG. 1 and the second light source unit 140 is controlled to be a non-emission state to display an image in the second mode, a field of view of images displayed on the second area A2 which provides an entertainment function and seat information for a passenger sitting on the front passenger seat is not completely restricted, but is visible to the driver located in the first area A1.

Accordingly, the display device 100 according to the example embodiment of the present disclosure may shift the light profile of light which travels toward the display panel 170, for example, the traveling direction of the light to the first direction X which is directed to the second area A2 using the second light controller 160.

To this end, the second light controller 160 may include a base layer 161 and a plurality of prism patterns 162 which is disposed on the base layer 161 and has an asymmetric triangular prism shape.

The base layer 161 may support the plurality of prism patterns 162.

The base layer 161 includes a transparent material to allow light to pass therethrough. For example, the base layer 161 may include a plastic material. For example, the base layer 161 may include polyethylene terephthalate. However, the material of the base layer 161 is not limited thereto and depending on the example embodiment, the base layer 161 may include a polymer, such as polystyrene, polyvinyl alcohol, polymethyl methacrylate, polycarbonate, polyethersulfone, polyacrylate, polyetherimide, polyethylene naphthalate, polyphenylene sulfide, polyarylate, or polyimide.

The plurality of prism patterns 162 may be disposed on the base layer 161. Each of the plurality of prism patterns 162 extends to the second direction Y on the base layer 161 and may be disposed along the first direction X. In the meantime, the plurality of prism patterns 162 may be coupled to the base layer 161 by means of a transparent adhesive, but is not limited thereto.

Each of the plurality of prism patterns 162 may include a plastic material including a transparent material to allow light to pass therethrough. Further, each of the plurality of prism patterns 162 may include a material having a refractive index which is different from that of vacuum or air, for example, is larger than that of the vacuum or air to shift the profile of light emitted from the second light controller 160. For example, a refractive index of the prism pattern 162 may have a value which is equal to or larger than 1.4 and equal to or smaller than 1.7, but the refractive index of the prism pattern 162 is not limited thereto.

For example, each of the plurality of prism patterns 162 may include polycarbonate. However, the material of the plurality of prism patterns 162 is not limited thereto and each of the plurality of prism patterns 162 may include a transparent material, such as polystyrene, polyvinyl alcohol, polymethyl methacrylate, polyacrylate, polyethylene terephthalate, or polyurethane and may be formed to include various known materials having the above-described refractive index.

Each of the plurality of prism patterns 162 may have an asymmetric triangular prism shape. For example, each of the plurality of prism patterns 162 may have an isosceles triangular shape as seen from a plane defined by the first direction X and the third direction Z.

To be more specific, further referring to FIG. 11, the prism pattern 162 may include a first surface 162a, a second surface 162b connected to one end of the first surface 162a, and a third surface 162c connected to the other end of the first surface 162a. The second surface 162b may be located in the first direction X, for example, in the second area A2 and the third surface 162c may be located in an opposite direction to the first direction X, for example, in the first area A1.

The first surface 162a of the prism pattern 162 may be a surface which is in contact with a top surface of the base layer 161. For example, the first surface 162a may correspond to a lower surface of the prism pattern 162. For example, the first surface 162a may be parallel to the first direction X.

A first angle AG1 between the first surface 162a and the second surface 162b of the prism pattern 162 may be designed to minimize the luminance degradation of light which passes through the prism pattern 162 and a side lobe. For example, the first angle AG1 between the first surface 162a and the second surface 162b of the prism pattern 162 may be 90°. For example, the second surface 162b of the prism pattern 162 may be parallel to the third direction Z which is perpendicular to the first direction X.

To be more specific, further referring to FIGS. 12a to 12d, graphs (reference) illustrated by one-dot chain line in FIGS. 12a to 12d for the luminance value according to the viewing angle when there is no prism pattern 162 and graphs illustrated by a solid line in FIGS. 12a to 12d for the luminance value according to the viewing angle when a first angle AGI of the prism pattern 162 of the display device 100 according to the example embodiment of the present disclosure is 60°, 70°, 80°, and 90°are illustrated. In the meantime, in FIGS. 12a to 12d, it is assumed that conditions other than the first angle AG1 of the prism pattern 162, for example, a second angle AG2 of the prism pattern 162, a length of the first surface 162a, and a refractive index are the same.

First, referring to FIG. 12a, when the first angle AG1 between the first surface 162a and the second surface 162b of the prism pattern 162 is 60°, a peak luminance of light which passes through the prism pattern 162 may be reduced by approximately 18.4% compared to the peak luminance in the absence of the prism pattern 162. Further, when the first angle AG1 between the first surface 162a and the second surface 162b of the prism pattern 162 is 60°, it is confirmed that the side lobe of light which passes through the prism pattern 162 is generated in the viewing angle between-60°and -90°.

Further, referring to FIG. 12b, when the first angle AG1 between the first surface 162a and the second surface 162b of the prism pattern 162 is 70°, a peak luminance of light which passes through the prism pattern 162 may be reduced by approximately 15.8% compared to the peak luminance in the absence of the prism pattern 162. Further, when the first angle AG1 between the first surface 162a and the second surface 162b of the prism pattern 162 is 70°, it is confirmed that the side lobe of light which passes through the prism pattern 162 is generated in the viewing angle between-40°and -80°.

Further, referring to FIG. 12c, when the first angle AG1 between the first surface 162a and the second surface 162b of the prism pattern 162 is 80°, a peak luminance of light which passes through the prism pattern 162 may be reduced by approximately 13.2% compared to the peak luminance in the absence of the prism pattern 162. Further, when the first angle AG1 between the first surface 162a and the second surface 162b of the prism pattern 162 is 80°, it is confirmed that the side lobe of light which passes through the prism pattern 162 is generated in the viewing angle between −20° and −40°.

Further, referring to FIG. 12d, when the first angle AG1 between the first surface 162a and the second surface 162b of the prism pattern 162 is 90°, a peak luminance of light which passes through the prism pattern 162 may be reduced by approximately 10.6% compared to the peak luminance in the absence of the prism pattern 162. Further, when the first angle AG1 between the first surface 162a and the second surface 162b of the prism pattern 162 is 90°, it is confirmed that the side lobe of light which passes through the prism pattern 162 is not generated. That is, the side lobe of light which passes through the prism pattern 162 having the first angle AG1 of 90° may be generated only in the vicinity of 0°.

As described above, when the first angle AG1 between the first surface 162a and the second surface 162b of the prism pattern 162 is 90°, the peak luminance has a maximum value and the side lobe may be converged to 0. That is, when the first angle AG1 between the first surface 162a and the second surface 162b of the prism pattern 162 is designed to be 90°, the luminance drop may be minimized and the side lobe may be minimized so that the viewing angle may be more effectively controlled in the second area A2.

Referring to FIG. 11 again, the second angle AG2 between the first surface 162a and the third surface 162c of the prism pattern 162 may have a value between 0° and 90°. For example, the second angle AG2 may be an acute angle.

The second angle AG2 of the prism pattern 162 may be designed by comprehensively considering the distance between the second light controller 160 and the display panel 170, a size of the display panel 170, an area of the second area A2, and the refractive index of the prism pattern 162.

For example, as illustrated in FIGS. 10 and 11, first light L1 which is incident to the prism pattern 162 may be refracted from the third surface 162c due to the difference in the refractive index of the vacuum or air and the prism pattern 162. At this time, as described above, the refractive index of the prism pattern 162 is larger than a refractive index of vacuum or air, for example, has a value which is equal to or larger than 1.4 and is equal to or smaller than 1.7. The first light L1 which is incident to the prism pattern 162 in the direction parallel to the third direction Z, for example, the first light L1 which is incident to the third surface 162c of the prism pattern 162 at an incident angle having a second angle AG2 with respect to the normal line NL for the third surface 162c is refracted to the first direction X on the third surface 162c due to the refractive index difference to be refracted at the third angle AG3 which is larger than the second angle AG2 by α° with respect to the normal line NL for the third surface 162c to upwardly travel. However, a is a real number which is larger than 0 and a value obtained by adding α° to the second angle AG2 may be smaller than 90°. Accordingly, the first light L1 which passes through the prism pattern 162 is shifted to the first direction X by α° from the light path before the light passes through the prism pattern 162 to upwardly travel. Here, α° may be determined by the refractive index of the vacuum or air and the refractive index of the prism pattern 162 according to the Snell's law.

Accordingly, referring to FIG. 10 again, the second light L2 which is not absorbed by the partition 133 of the first light controller 130, but is totally reflected to travel toward the first area A1, for example, in an opposite direction of the first direction X passes through the prism pattern 162 of the second light controller 160 and then is shifted to the first direction X to upwardly travel, for example, toward the display panel 170.

Accordingly, when in the above-described second mode, light which is emitted from the first light source unit 110 disposed below the first light controller 130, and overlaps the second area A2 travels to the display panel 170 through the first light controller 130, even though there is light which is not absorbed on the partition 133 included in the first light controller 130, but is totally reflected to travel in the opposite direction of the first direction X, that is, toward the first area A1, the light is shifted to the first direction X through the second controller 160 to travel toward the display panel 170. Therefore, the viewing angle may be more effectively controlled on the second area A2.

Further, the plurality of prism patterns 162 may be disposed in an area overlapping the second area A2. For example, the plurality of prism patterns 162 may be disposed on the second area A2 and may not be disposed on the first area A1. Accordingly, light which travels to the display panel 170 on the second area A2 in which the viewing angle is restricted in the second mode may be shifted to the first direction X by the second light controller 160 including a plurality of prism patterns 162 disposed in an area overlapping the second area A2.

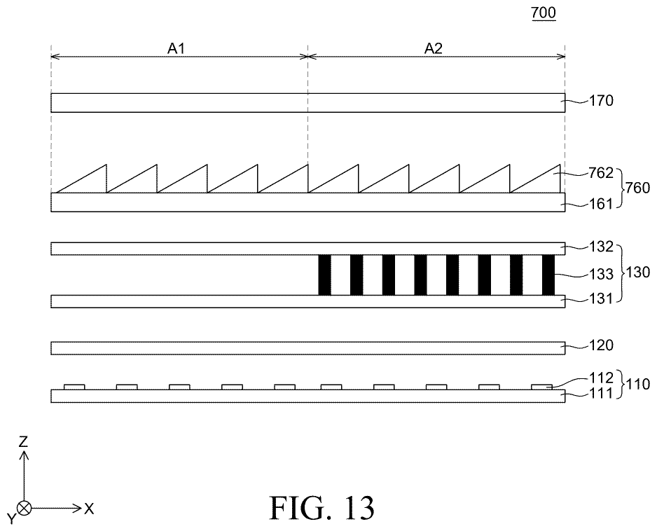

FIG. 13 is a side view of a display device according to another example embodiment of the present disclosure.

In the meantime, FIG. 13 illustrates a modified embodiment of the example embodiment of FIG. 10 with regard to an area in which a plurality of prism patterns 762 included in the second light controller 760 is disposed. Accordingly, in FIG. 13, in order to avoid a redundant description, differences from the above-described example embodiments will be mainly described.

Referring to FIG. 13, the second light controller 760 included in the display device 700 according to another example embodiment of the present disclosure may include a base layer 161 and a plurality of prism patterns 762 disposed on the base layer 161.

The plurality of prism patterns 762 may be disposed on the entire active area AA. For example, the plurality of prism patterns 762 may be disposed on the base layer 161 while overlapping the first area A1 and the second area A2.

As such, the prism pattern is not formed only in a partial area of the active area AA, but a plurality of prism patterns 762 is formed on the entire area of the active area AA, during the manufacturing process of the second light controller 760 so that the manufacturing process of the second light controller 760 may be further simplified.

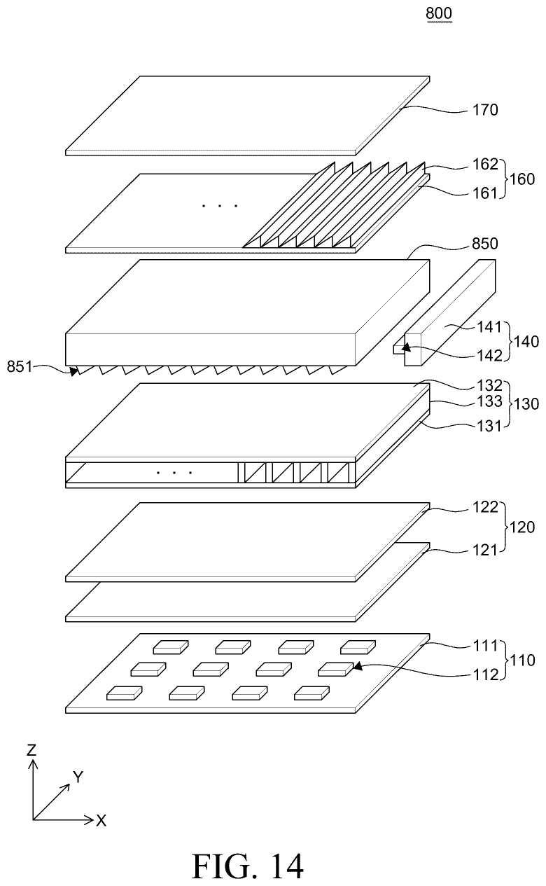

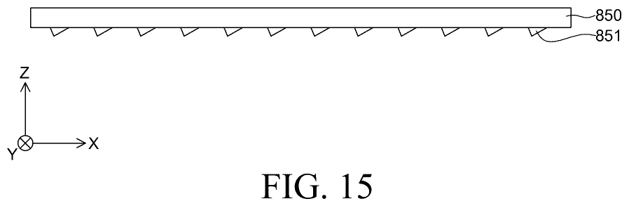

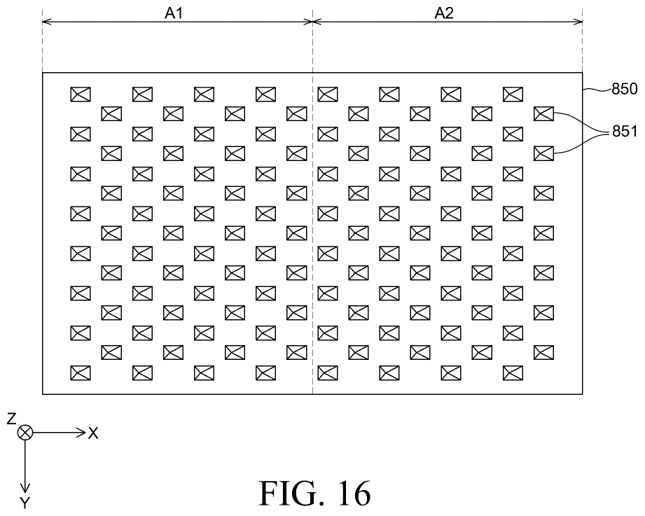

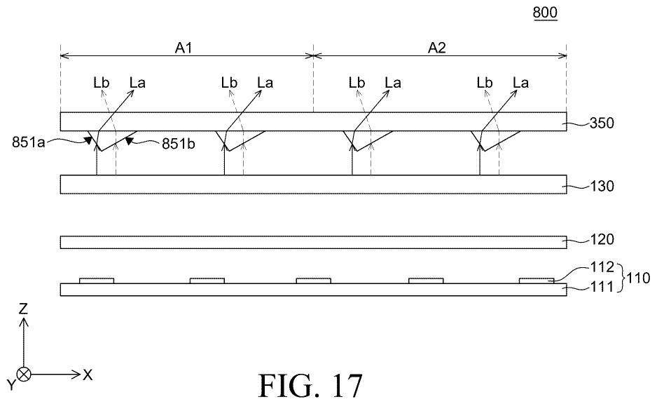

FIG. 14 is an exploded perspective view of a display device according to still another example embodiment of the present disclosure. FIG. 15 is a side view schematically illustrating an example of a light guide plate included in a display device of FIG. 14. FIG. 16 is a rear view schematically illustrating an example of a light guide plate included in a display device of FIG. 14. FIG. 17 is a side view of a display device according to still another example embodiment of the present disclosure.

In the meantime, FIG. 14 illustrates a modified embodiment of the example embodiment of FIG. 2 with regard to the light guide plate 850. Accordingly, in FIGS. 14 to 17, in order to avoid a redundant description, differences from the above-described example embodiments will be mainly described.

Referring to FIG. 14, the display device 800 according to still another example embodiment of the present disclosure may include a first light source unit 110, at least one optical sheet 120, a first light controller 130, a second light source unit 140, a light guide plate 850, a second light controller 160, and a display panel 170.

The light guide plate 850 is disposed on the first light controller 130 and may be disposed on a side portion of the second light source unit 140. The light guide plate 850 guides light provided from the second light source unit 140 to allow the light to travel in a direction directed to the display panel 170, for example, in the third direction Z.

The light guide plate 850 may include a plurality of protrusion patterns 851 disposed on a lower surface. Each of the plurality of protrusion patterns 851 may include a material having a refractive index which is different from that of vacuum or air, for example, a refractive index which is higher than the refractive index of vacuum or air. For example, each of the plurality of protrusion patterns 851 includes the same material as the light guide plate 850 so that each of the plurality of protrusion patterns 851 may have the same refractive index as the light guide plate 850, but is not limited thereto.

Referring to FIGS. 15 and 16 together, the plurality of protrusion patterns 851 may be formed to protrude in a lower direction of the light guide plate 850, for example, in an opposite direction of the third direction Z. Depending on the example embodiment, the plurality of protrusion patterns 851 may be disposed on the bottom surface of the light guide plate 850 with the constant density and interval, but is not limited thereto.

Each of the plurality of protrusion patterns 851 may have planes, for example, four inclined surfaces which form a predetermined angle with a surface defined by the first direction X and the second direction Y. For example, the plurality of protrusion patterns 851 may have a square pyramid shape.

The square pyramid shape of each of the plurality of protrusion patterns 851 may have an asymmetrical shape. For example, square pyramid-shaped vertices included in each of the plurality of protrusion patterns 851 may be formed in the first direction X, for example, toward the first area A1. Accordingly, as illustrated in FIG. 16, between two inclined surfaces which are included in the square pyramid shape of each of the plurality of protrusion patterns 851 and are opposite to each other along the first direction X, an inclined surface located in the first direction X may be formed to be larger than an inclined surface located in an opposite direction to the first direction X.

A profile of light which passes through the light guide plate 850 may be shifted toward the second area A2, that is, toward the first direction X, due to the shape of the protrusion pattern 851. For example, further referring to FIG. 17, the square pyramid shape of each of the plurality of protrusion patterns 851 has an asymmetrical shape. Accordingly, inclination angles of two inclined surfaces 851a and 851b which are included in each of the plurality of protrusion patterns 851 and are opposite to each other along the first direction X may be different. For example, between two inclined surfaces 851a and 851b which are opposite to each other along the first direction X, an inclination angle of the first inclined surface 851a which is located in the opposite direction to the first direction X may be larger than an inclination angle of the second inclined surface 851b which is located in the first direction X.

Accordingly, an angle of light La which is incident to the first inclined surface 851a included in each of the plurality of protrusion patterns 851 and is refracted to the first direction X by the protrusion pattern 851 may be larger than an angle of light Lb which is incident to the second inclined surface 851b and is refracted to the opposite direction to the first direction X by the protrusion pattern 851. Therefore, the light which is provided from the bottom of the light guide plate 850 may be entirely shifted to the second area A2. Accordingly, in the above-described second mode, the viewing angle of the second area A2 may be more effectively controlled. Further, light which passes through the second light controller 160 is shifted to the first direction X which is directed to the second area A2 so that the viewing angle in the second area A2 may be improved.

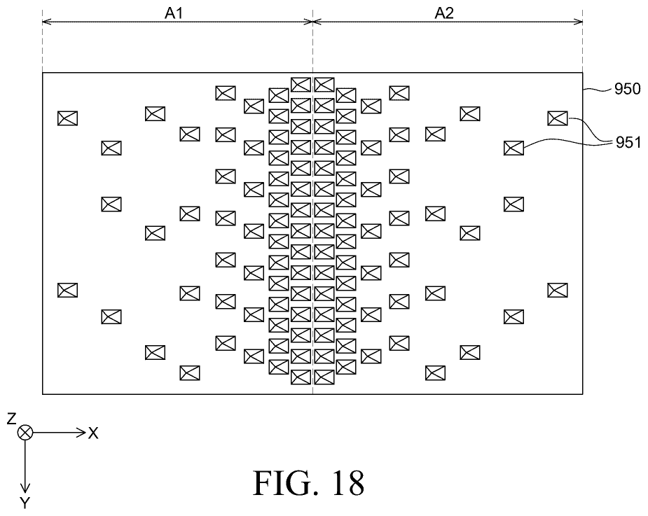

FIG. 18 is a rear view schematically illustrating another example of a light guide plate included in a display device of FIG. 15.

In the meantime, FIG. 18 illustrates a modified embodiment of the example embodiment of FIG. 16 with regard to the placement of the protrusion pattern 951. Accordingly, in FIG. 18, in order to avoid a redundant description, differences from the above-described example embodiments will be mainly described.

Referring to FIG. 18, a light guide plate 950 may include a plurality of protrusion patterns 951 which is disposed on a bottom surface and is formed to protrude in a lower direction of the light guide plate 950, for example, in an opposite direction of the third direction Z. The plurality of protrusion patterns 951 may be disposed on the bottom surface of the light guide plate 950 with a different density in each area. In the meantime, in the present disclosure, the density with which the protrusion patterns 951 are disposed may be defined as a percentage (%) of an area in which the protrusion patterns 951 are disposed with respect to the entire area of the unit area.

For example, the plurality of protrusion patterns 951 may be disposed in the first area A1 with a first density and may be disposed in the second area A2 with a second density which is larger than the first density. Here, the plurality of protrusion patterns 951 which shifts the light passing through the light guide plate 950 to the first direction X is disposed with a higher density in the second area A2 in which the viewing angle is restricted during driven in the second mode than in the first area A1 depending on the driving mode. Therefore, the viewing angle in the second area A2 may be more effectively controlled.

Further, the plurality of protrusion patterns 951 may be disposed with the third density which is larger than the second density, in the vicinity of the boundary between the first area A1 and the second area A2. Accordingly, the visibility in the vicinity of the boundary between the first area A1 and the second area A2 may be minimized.

The example embodiments of the present disclosure can also be described as follows:

A display device according to an aspect of the present disclosure comprises a first light source unit including a plurality of first light sources, first light controller disposed on the first light source unit and includes a plurality of partitions overlapping at least a partial area of an active area, a second light source unit disposed on the first light controller and includes a plurality of second light sources, a light guide plate disposed to be parallel to the second light source unit and guides light provided from the second light source unit, a second light controller disposed on the light guide plate and includes a plurality of prism patterns overlapping at least a partial area of the active area, and a display panel disposed on the second light controller and displays an image using light provided from the first light source unit or the second light source unit.

Each of the plurality of prism patterns may extend in a second direction which may be an extending direction of the plurality of partitions and be disposed along a first direction which may be different from the second direction.

Each of the plurality of prism patterns may have an asymmetric triangular prism shape.

Each of the plurality of prism patterns may include a first surface parallel to the first direction, a second surface connected to one end of the first surface, and a third surface connected to the other end of the first surface.

A first angle between the first surface and the second surface may be 90° and an angle between the first surface and the third surface may be an acute angle.

Each of the plurality of prism patterns may include a transparent plastic material and each of the plurality of prism patterns may have a refractive index smaller than a refractive index of air.

The refractive index of each of the plurality of prism patterns may be equal to or larger than 1.4 and equal to or smaller than 1.7.

The second light controller may further include a base layer which may support the plurality of prism patterns.

The base layer may include a transparent plastic material.

The active area may include a first area in which an image may be displayed at a first viewing angle in a first mode and a second mode, respectively; and a second area in which an image may be displayed at the first viewing angle in the first mode and an image may be displayed at a second viewing angle which may be smaller than the first viewing angle in the second mode.

The plurality of prism patterns may be disposed in an area overlapping the second area and may be not disposed in an area overlapping the first area.

The plurality of prism patterns may be disposed in an area overlapping the first area and the second area.

In the first mode, all the plurality of first light sources and the plurality of second light sources may emit light and in the second mode, the plurality of first light sources emits light, but the plurality of second light sources may do not emit light.

The plurality of partitions may be disposed in an area overlapping the first area and the second area and among the plurality of partitions, a partition disposed in an area overlapping the first area and a partition disposed in an area overlapping the second area may have different heights.

Although the example embodiments of the present disclosure have been described in detail with reference to the accompanying drawings, the present disclosure is not limited thereto and may be embodied in many different forms without departing from the technical concept of the present disclosure. Therefore, the example embodiments of the present disclosure are provided for illustrative purposes only but not intended to limit the technical concept of the present disclosure. The scope of the technical concept of the present disclosure is not limited thereto. Therefore, it should be understood that the above-described example embodiments are illustrative in all aspects and do not limit the present disclosure. All the technical concepts in the equivalent scope of the present disclosure thereof should be construed as falling within the scope of the present disclosure.

1. A display device, comprising:
a first light source unit including a plurality of first light sources;
a first light controller disposed on the first light source unit and includes a plurality of partitions overlapping at least a partial area of an active area;
a second light source unit disposed on the first light controller and includes a plurality of second light sources;
a light guide plate disposed to be parallel to the second light source unit and configured to guide light provided from the second light source unit;
a second light controller disposed on the light guide plate and includes a plurality of prism patterns overlapping at least a partial area of the active area; and
a display panel disposed on the second light controller and configured to display an image using light provided from the first light source unit or the second light source unit.

2. The display device of claim 1, wherein each of the plurality of prism patterns extends in a second direction which is an extending direction of the plurality of partitions and is disposed along a first direction which is different from the second direction.

3. The display device of claim 1, wherein each of the plurality of prism patterns has an asymmetric triangular prism shape.

4. The display device of claim 3, wherein each of the plurality of prism patterns includes a first surface parallel to a first direction, a second surface connected to one end of the first surface, and a third surface connected to the other end of the first surface.

5. The display device of claim 4, wherein a first angle between the first surface and the second surface is 90°, and wherein an angle between the first surface and the third surface is an acute angle.

6. The display device of claim 1, wherein each of the plurality of prism patterns includes a transparent plastic material, and wherein each of the plurality of prism patterns has a refractive index smaller than a refractive index of air.

7. The display device of claim 6, wherein the refractive index of each of the plurality of prism patterns is equal to 1.4 or 1.7 or is larger than 1.4 and smaller than 1.7.

8. The display device of claim 1, wherein the second light controller further includes a base layer which supports the plurality of prism patterns.

9. The display device of claim 8, wherein the base layer includes a transparent plastic material.

10. The display device of claim 1, wherein the active area includes a first area in which an image is being displayed at a first viewing angle in a first mode and a second mode, respectively; and a second area in which an image is being displayed at the first viewing angle in the first mode and an image is being displayed at a second viewing angle which is smaller than the first viewing angle in the second mode.

11. The display device of claim 10, wherein the plurality of prism patterns is disposed in an area overlapping the second area and is not disposed in an area overlapping the first area.

12. The display device of claim 10, wherein the plurality of prism patterns is disposed in an area overlapping the first area and the second area.

13. The display device of claim 10, wherein in the first mode, all of the plurality of first light sources and the plurality of second light sources are configured to emit light, and wherein in the second mode, the plurality of first light sources is configured to emit light, but the plurality of second light sources is configured to not emit light.

14. The display device of claim 10, wherein the plurality of partitions is disposed in an area overlapping the first area and the second area, and wherein among the plurality of partitions, a partition disposed in an area overlapping the first area and a partition disposed in an area overlapping the second area have different heights.
